(19) United States
(12) Patent Application Publication
(10) Pub. No.: US 2012/0026009 A1
(43) Pub. Date: Feb. 2, 2012

(54) MEDICAL DEVICE HAVING A MULTI-ELEMENT ANTENNA

(76) Inventors: Yanzhu Zhao, Blaine, MN (US); Gregory J. Haubrich, Champlin, MN (US); Quentin S. Denzene, Andover, MN (US)

(21) Appl. No.: 13/191,857

(22) Filed: Jul. 27, 2011

Related U.S. Application Data
(60) Provisional application No. 61/369,184, filed on Jul. 30, 2010.

(51) Int. Cl. G08C 17/00

(52) U.S. Cl. 340/870.28

(57) ABSTRACT

Medical devices are provided with multi-element antenna systems that may function to automatically tune the antenna as a function of the operating environment of the medical device. The tuning methodology may incorporate a multi-element antenna having a variable capacitive element on a first of the antenna elements with that antenna element being driven by a second of the antenna elements. In an embodiment, a multi-element antenna system may acquire measurements of predefined criteria and the antenna may be tuned as a function of the measured criteria to optimize operation of the antenna in both reception and transmission of signals. In so doing the antenna impedance can be matched to the transmission line impedance.

### CROSS-REFERENCE TO RELATED APPLICATIONS

This patent application claims priority to provisional U.S. patent application Ser. No. 61/369,184 entitled “MULTI-LOOP ANTENNA FOR A BODY WORN DEVICE” (Attorney Docket No. P0036139.00) filed Jul. 30, 2010, which is incorporated herein by reference in its entirety.

### TECHNICAL FIELD

The disclosure relates generally to wireless communications between medical devices such as implantable medical devices (IMDs) and, in particular, to multi-element antennas for wireless communications of the devices.

### BACKGROUND

A wide variety of implantable medical devices (IMDs) that deliver a therapy to or monitor a physiologic or biological condition of a patient, or both, have been clinically implanted or proposed for clinical implantation in patients. An IMD may deliver therapy to or monitor a physiological or biological condition with respect to a variety of organs, nerves, muscles or tissues of the patients, such as the heart, brain, stomach, spinal cord, pelvic floor, or the like. The therapy provided by the IMD may include electrical stimulation therapy, drug delivery therapy or the like.

The IMD may exchange communications with another device. The IMD may exchange communications with a body worn device that is either attached to (e.g., worn by) the patient or otherwise located near the patient. The information exchanged may be information related to a condition of the patient, such as physiological signals measured by one or more sensors, or information related to a therapy delivered to the patient. This information may be previously stored or real-time information. The IMD may also receive information from the body worn device, such as information that may be used to control or configure a therapy to be provided to the patient.

The IMD and the body worn device (collectively “medical devices”) may exchange information using any of a variety of communication techniques, such as radio frequency (RF) communications. For example, the IMD and the other device may communicate in the 402-405 megahertz (MHz) frequency band in accordance with the Medical Device Radiocommunications Service (MEDRADIO) band regulations. As another example, the IMD and the other device may communicate over the 401-402 MHz or 405-406 MHz frequency bands in accordance with the MEDRADIO band regulations.

In RF communications, the reliability and efficiency of wireless communication systems are often affected by the environment in which the communications occur. Yet, the medical devices will typically operate in a variety of environments each of which may impact the tuning of the RF antenna. The body worn device will operate in both wearable and non-wearable environments. As for the IMD, the device will typically be operational in an external environment prior to implantation, while the implant environment will vary depending on such things as implant depth, orientation etc. Therefore, the need remains for a tunable antenna for optimizing communications of the medical devices in a variety of operating environments.

### SUMMARY

In general, the exemplary embodiments of the present disclosure provide medical devices comprising a tunable antenna. In an embodiment, the antenna comprises a multi-element assembly including at least a first inner element nested within at least a first outer element. In an implementation, the first inner element and first outer element may share a central axis with at least a portion of the first inner element overlapping with the outer element to enable magnetic coupling between the elements. In other implementations, the first inner element and the first outer element may be configured in an offset axis.

In an embodiment, one of the at least first inner element and the first outer element may be formed in a loop configuration. In another embodiment, one of the at least first inner element and the first outer element may be formed in a square configuration. In another embodiment, the at least first inner element and the first outer element may be formed in a rectangular configuration. In another embodiment, the at least first inner element and the first outer element may be formed in a helical configuration. In another embodiment, the at least first inner element and the first outer element may be formed in a spiraling configuration.

In an exemplary embodiment, a tuning network may be coupled to the outer antenna element. The tuning network may be a component that will facilitate varying of the impedance of the antenna in response to changes to one or more electrical properties of the tuning network. Such changes may include but are not limited to varying an input such as a voltage or current to the tuning network. In one or more embodiments, the tuning network may be a variable capacitor, or a variable inductor, or a switched network implemented with a plurality of capacitors or inductors or a combination of both a capacitor and an inductor.

According to yet another embodiment, an apparatus comprises a telemetry module, and an antenna coupled to the telemetry module. The antenna may comprise a first antenna element that is selectively electrically-coupled to the telemetry module via a feed point, a second antenna element that is coupled to the first antenna element, and a tuning network that is selectively tuned in response to an operating environment of the apparatus. In some implementations, the antenna may further comprise a third antenna element that is selectively electrically-coupled to the telemetry module via the feed point, wherein one of the first antenna element and the third antenna element is coupled to the telemetry module via the feed point in response to the operating environment of the apparatus. Yet further, the tuning network may comprise a configurable network having at least a first switchable component and at least a first non-switchable component. In other embodiments, the tuning network may comprise a passive network having a tuning element that passively adjusts an electrical characteristic in response to a change in the operating environment of the apparatus.

According to an alternate embodiment, the antenna may comprise a tuning module that generates tuning signals to apply to the tuning network. The tuning module may selectively apply the tuning signals to adjust an electrical characteristic of the tuning network to a first value in response to the apparatus being disposed in a first operating environment and to adjust the electrical characteristic of the tuning network to a second value in response to the apparatus being disposed in a second operating environment, wherein the first value is different than the second value. For example, the first value may be smaller in comparison to the second value.

In another aspect of the disclosure a method comprises determining the operating environment in which a device is disposed selectively tuning an antenna of the device based on the determination.

According to another embodiment, an antenna is provided comprising a plurality of antenna elements, wherein two of the elements are selected to define a first outer antenna element and a first inner antenna element, providing optimum antenna performance (e.g. impedance matching and efficiency).

According to another aspect of the disclosure, the antenna may have a feed-point through which the inner antenna element or the outer antenna element or both may be coupled to a telemetry module. For example, the power applied to the inner antenna element induces a magnetic field that couples to the outer antenna element. The coupling can effect an impedance transformation to impedance match the antenna's feed-point, and in turn may optimize the performance of the antenna by allowing the larger outer element to operate at higher tuning element Q.

### BRIEF DESCRIPTION OF THE DRAWINGS

The following drawings are illustrative of particular embodiments of the present disclosure and therefore do not limit the scope of the disclosure. The drawings (not to scale) are intended for use in conjunction with the explanations in the following detailed description, wherein similar elements are designated by identical reference numerals. Moreover, the specific location of the various features is merely exemplary unless noted otherwise.

FIG. 1 is a conceptual diagram illustrating an example medical system.

FIG. 2 is a block diagram illustrating an example body worn device in further detail.

FIG. 3 is a schematic diagram illustrating an example multi-element antenna in accordance with one aspect of this disclosure.

FIG. 4A is a schematic diagram of a wrist-worn device.

FIG. 4B is a schematic diagram illustrating a top view of one example antenna configuration for the wrist worn device of FIG. 4A.

FIG. 4C is a schematic diagram illustrating a side view of another example antenna configuration for the wrist worn device of FIG. 4A.

FIG. 5 is a schematic diagram illustrating another example multi-element antenna.

FIG. 6 is a schematic diagram illustrating another example antenna in accordance with this disclosure.

FIG. 7 is a schematic diagram depicting an alternative embodiment of a multi-element antenna 70.

FIG. 8 is a schematic block diagram illustrating a system for real-time automatic self-tuning of antennas of the present disclosure.

FIG. 9 is a flow diagram illustrating example operation of a body worn device in accordance with one aspect of this disclosure.

### DETAILED DESCRIPTION

The following detailed description is merely exemplary in nature and is not intended to limit the disclosure or the application and uses of the disclosure. Furthermore, there is no intention to be bound by any expressed or implied theory presented in the preceding technical field, background, brief summary or the following detailed description.

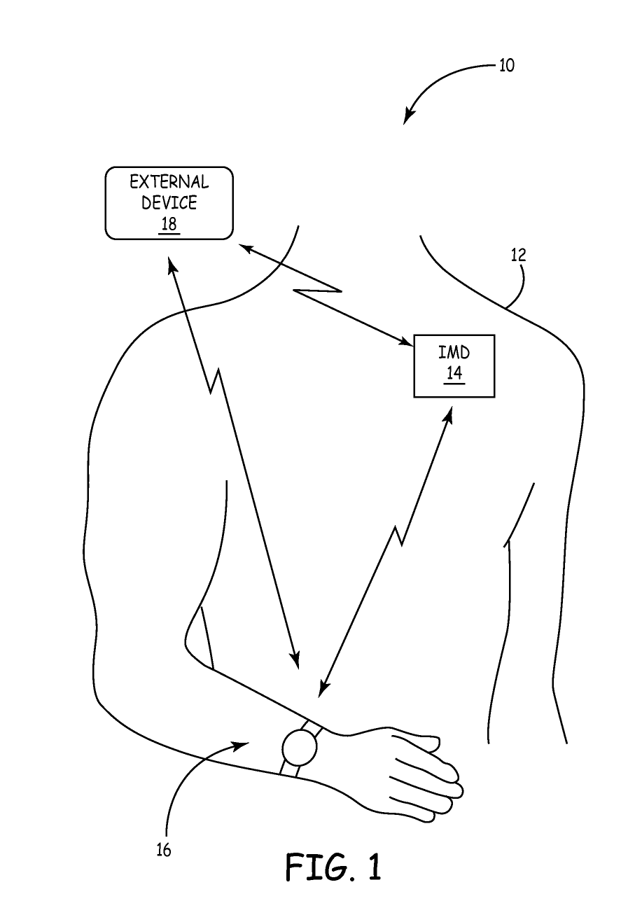

FIG. 1 is a conceptual diagram illustrating an example medical system 10. Medical system 10 includes an implantable medical device (IMD) 14, a body worn device 16 and an external device 18. Medical system 10 may, however, include more or fewer devices. IMD 14, body worn device 16 and external device 18 communicate with one another using any of a number of wireless communication techniques.

IMD 14 may be any of a variety of medical devices that provide therapy to patient 12, sense one or more parameters of patient 12 or a combination thereof. In some instances, IMD 14 may be a device that provides electrical stimulation therapy in the form of cardiac rhythm management therapy to a heart of patient 12 via one or more electrodes. In one example, IMD 14 may include one or more implantable leads (not shown) with one or more electrodes that extend from IMD 14 for delivering therapy to and/or sensing physiological signals of a heart of patient 12. The leads may be implanted within one or more atria or ventricles of the heart of patient 12 or a combination thereof. In this manner, IMD 14 may be used for single chamber or multi-chamber cardiac rhythm management therapy. The cardiac rhythm management therapy delivered by IMD 14 may include, for example, pacing, cardioversion, defibrillation and/or cardiac resynchronization therapy (CRT). In other instances, IMD 14 may be a device that provides electrical stimulation to a tissue site of patient 12 proximate a muscle, organ or nerve, such as a tissue proximate a vagus nerve, spinal cord, brain, stomach, pelvic floor or the like to treat various conditions, including movement and affective disorders such as chronic pain, Parkinson's disease, tremor and dystonia, urinary storage and voiding dysfunction, digestion dysfunction, sexual dysfunction or the like.

In other instances, IMD 14 may be a device that delivers a drug or therapeutic agent to patient 12 via an implantable catheter (not shown). IMD 14 may, for example, be implanted within a subcutaneous pocket in an abdomen of patient 12 and the catheter may extend from IMD 14 into the stomach, pelvic floor, brain, intrathecal space of the spine of patient 12 or other location depending on the application. IMD 14 may deliver the drug or therapeutic agent via the catheter to reduce or eliminate the condition of the patient and/or one or more symptoms of the condition of the patient. For example, IMD 14 may deliver morphine or ziconotide to reduce or eliminate pain, baclofen to reduce or eliminate spasticity, chemotherapy to treat cancer, or any other drug or therapeutic agent to treat any other condition and/or symptom of a condition.

In further instances, IMD 14 may be a leadless IMD. In this case, the IMD is implanted at a target site with no leads extending from the IMD. The leadless IMD may provide therapy and/or sense various parameters via one or more electrodes or sensors on the device, thus avoiding limitations associated with lead-based sensors. For example, IMD 14 may be a leadless pacer. As another example, IMD 14 may be a leadless pressure sensor placed within or near the heart, such as in the pulmonary artery. In some instances, IMD 14 uses the sensed signals to monitor a condition of patient 12 or provide therapy to patient 12 as a function of the sensed physiological signals. Alternatively, or additionally, IMD 14 transmits the sensed physiological signals to another device, such as body worn device 16 or external device 18, which may in turn monitor the condition of patient 12 or provide therapy to patient 12 as a function of sensed physiological signals. IMD 14 may sense, sample, and process one or more physiological signals such as heart activity, muscle activity, brain electrical activity, intravascular pressure, blood pressure, blood flow, acceleration, displacement, motion, respiration, or blood/tissue chemistry, such as oxygen saturation, carbon dioxide, pH, protein levels, enzyme levels or other parameter.

Body worn device 16 is illustrated in FIG. 1 as being a watch. However, body worn device 16 may be any of a variety of body worn devices, such as a necklace, armband, belt, ring, bracelet, patch, or other device that is configured to be attached to, worn by, placed on or otherwise coupled to a body of patient 12 or placed in close proximity to patient 12. As will be described in further detail in this disclosure, body worn device 16 is capable of wireless communication while on patient 12 and while off patient 12.

External device 18 may be a programming device or monitoring device that allows a user, e.g., physician, clinician or technician, to configure a therapy delivered by IMD 14 or to retrieve data sensed by IMD 14 or body worn device 16. External device 18 may include a user interface that receives input from the user and/or displays data to the user, thus allowing the user to program the therapy delivered by IMD 14 or display data retrieved from IMD 14 and/or body worn device 16. External device 18 may be a dedicated hardware device with dedicated software for programming or otherwise communicating with IMD 14 and/or body worn device 16. In one example, external device 18 may be a programmer, such as a CareLink® programmer, available from Medtronic, Inc. of Minneapolis, Minn. CareLink® is a registered trademark of Medtronic, Inc. Alternatively, external device 18 may be an off-the-shelf computing device running an application that enables external device 18 to program or otherwise communicate with IMD 14 and/or body worn device 16.

IMD 14, body worn device 16 and external device 18 may communicate with one another by any of a number of wireless communication techniques. In some instances, IMD 14, body worn device 16 and external device 18 may be communicatively coupled with each other as well as other medical devices (not shown) to form a local area network, sometimes referred to as a body area network (BAN) or personal area network (PAN). Each device may therefore be enabled to communicate wirelessly along multiple pathways with each of the other networked devices. As such, IMD 14, body worn device 16 and external device 18 may represent a distributed system of devices that cooperate to monitor a condition of and/or provide therapy to patient 12.

Example wireless communication techniques include RF telemetry, but other techniques are also contemplated, including inductive telemetry, magnetic telemetry, or the like. In one instance, IMD 14, body worn device 16 and/or external device 18 may communicate in accordance with the Medical Device Radiocommunication Service (MEDRADIO)—Core and Wing—band regulation, MEDRADIO WING. As is known in the art, in countries other than the United States, MEDRADIO core band is known as Medical Implant Communications Service (MICS) and MEDRADIO wing band is known as Medical Data Service (MEDS). The MEDRADIO band regulation defines communication requirements for the 402-405 MHz frequency band. In accordance with the MEDRADIO band regulations, the frequency band may be divided into ten channels with each channel corresponding to a 300 kilohertz (kHz) sub-band. The MEDRADIO band regulation defines a split channel band with a portion of the MEDRADIO band occupying the 401-402 MHz frequency band and a portion of the MEDRADIO band occupying the 405-406 MHz frequency band. The MEDRADIO band may be divided into 20 channels with each channel corresponding to a 100 kHz sub-band, with the first ten channels being located in the 401-402 MHz frequency band and the second ten channels being located in the 405-406 MHz frequency band. The devices of medical system 10 may, however, communicate using any frequency band regulation in addition to or instead of the MEDRADIO Core and MEDRADIO Wing band regulations.

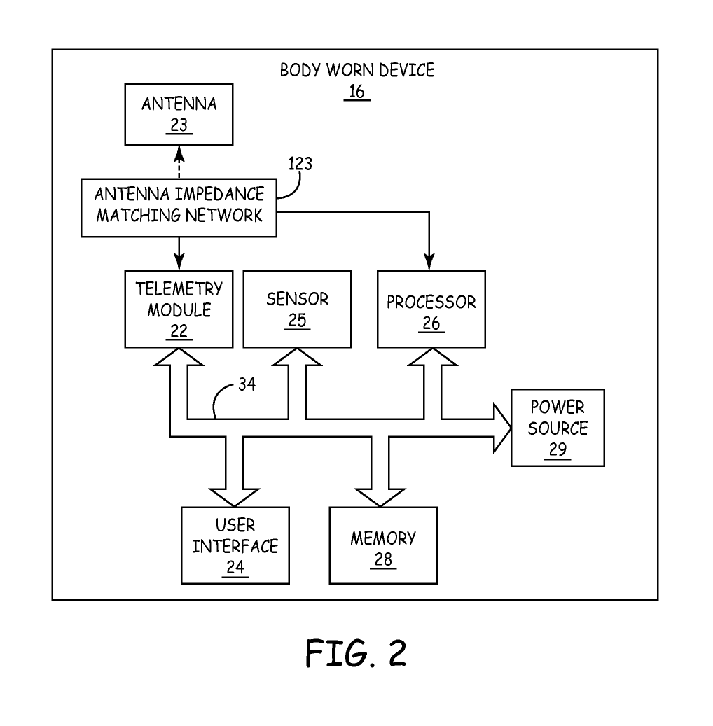

FIG. 2 is a block diagram illustrating example components of body worn device 16 in further detail. Body worn device 16 may be a watch, armband, belt, ring, bracelet, patch, or other device that is attached to, worn by, placed on or otherwise coupled to a body of patient 12. Body worn device 16 includes a telemetry module 22, antenna 23, antenna impedance matching network 123, user interface 24, sensor 25, processor 26, memory 28 and power source 29. The components of body worn device 16 are shown to be interconnected by a bus 34, but may be interconnected by other means including direct electrical or non-electrical connections.

As described above, body worn device 16 may wirelessly communicate with an IMD 14 and/or an external device 16 via telemetry module 22 and antenna 23. To this end, telemetry module 22 includes suitable hardware, firmware, software or any combination thereof for communicating with IMD 14 and/or external device 16. For example, telemetry module 22 may include appropriate modulation, demodulation, frequency conversion, filtering, and amplifier components for transmission and reception of data. In some instances, telemetry module 22 may include two or more sets of components, e.g., one for inductive communication and one for RF communication.

Antenna 23 may be a multi-element antenna as described in detail in this disclosure. Antenna impedance matching network is depicted coupled to antenna 23 in dashed line. The dashed-line coupling is intended to clarify that the matching network 123 may be included as part of antenna 23 or as a separate component. As such, in embodiments where antenna impedance matching network 123 is a separate component, the matching network 123 is coupled to telemetry module 22 rather than direct coupling of telemetry module 22 to antenna 23.

Body worn device 16 is typically worn by patient 12. In the case of a watch, for example, the watch is typically worn around a wrist of patient 12. There may be instances in which body worn device 16 is not worn by patient 12, but instead is placed nearby patient 12, such as in a pocket or a handbag. Conventional body worn devices may have an antenna designed or tuned for operation in response to being worn by the patient. However, in response to the conventional body worn devices not being worn by the patient, the antenna is no longer tuned correctly due to the environmental change (e.g., change in location). The antenna of conventional body worn devices may also be affected by other environmental changes, such as a temperature changes (e.g., worn in summer vs. winter, for example), dampness changes (e.g., worn in water or not), or the like. In accordance with this disclosure, body worn device 16 has a multi-element antenna that may be selectively tuned based on such environmental changes, as described in further detail below.

In one embodiment, body worn device 16 may be selectively tuned based on whether body worn device 12 is on patient 12. Body worn device 16 determines whether body worn device 16 is on patient 12. In one example, body worn device 16 may determine whether body worn device 16 is on patient based on a characteristic of a received signal, such as a received signal strength indication (RSSI), bit error rate (BER), bit rate, or other channel or signal quality metric. After the communication link is set up between body worn device 16 and IMD 14, telemetry module 22 may determine the RSSI of the received signals from IMD 14. Processor 26 may determine whether the RSSI is strong enough and if not, re-tune antenna 23. If antenna 23 is tuned for communication while body worn device 16 is worn on patient 12, an RSSI below a threshold may indicate that body worn device is no longer on patient 12 and processor 26 may re-tune antenna 23 for communication while body worn device 16 is not worn on patient 12. Similarly, if antenna 23 is tuned for communication in response to body worn device 16 not being worn on patient 12, an RSSI below the threshold may indicate that body worn device is on patient 12 and processor 26 may re-tune antenna 23 for communication while body worn device 16 is on patient 12. In this manner, processor 26 may determine whether or not body worn device is on patient 12 based on the RSSI (or other channel or signal quality metric). Tuning antenna 23 based on the determined RSSI may also account for other operating environment changes in addition to whether body worn device 16 is worn by patient 12, such as temperature of the environment, whether the environment is wet or dry, or the like.

In another example, sensor 25 may detect whether body worn device 16 is on or proximate to patient 12. Sensor 25 may, for example, be a proximity sensor that is capable of detecting when body worn device 16 is on patient 12. The proximity sensor may be a capacitive proximity sensor, inductive proximity sensor, ultrasonic proximity sensor, infrared (IR) proximity sensor or any other type of proximity sensor. In the case of a capacitive proximity sensor, the proximity sensor may be composed of one or more capacitive elements that measure the change in capacitance due to the proximity of the sensor to skin of patient 12. In another example, sensor 25 may be one or more electrodes located on body worn device 16. The electrodes may detect cardiac electrical signals of patient 12 to identify when body worn device 16 is on patient 12.

In a further example, patient 12 may interact with user interface 24 to indicate whether body worn device 16 is on patient 12. Body worn device 16 may, for example, include an input mechanism (such as one or more buttons, touch screens or the like) that the user may interact with to indicate whether body worn device 16 is on patient 12. Patient 12 interact with the input mechanism upon placing body worn device 16 on the body of patient 12 and interact with the input mechanism upon removing body worn device 16 on the body of patient 12. An output mechanism may indicate to patient 12 whether the antenna is tuned to function on the body or off the body to confirm correct antenna configuration. As will be described in detail below, a tuning module may selectively tune antenna 23 based on the determination as to whether patient 12 is wearing body worn device 16. The tuning module may be telemetry module 22, processor 26 or other component of body worn device 16.

In addition to detecting whether body worn device 16 is on patient 12, sensor 25 may also measure one or more parameters of patient 12. In the example in which sensor 25 includes one or more electrodes, sensor 25 may measure cardiac electrical signals of patient 12. Alternatively or additionally, body worn device 16 may include one or more separate sensors for measuring the one or more parameters of patient 12. In either case, processor 26 may store the measured signals in memory 28 for later processing or transmission to another device, e.g., external device 18 or a remote server (not shown).

Power source 29 delivers operating power to the components of body worn device 16. In one example, power source 29 may include a battery and a power generation circuit to produce the operating power for the components of body worn device 16. Power source 29 may be rechargeable or non-rechargeable. In the case of a rechargeable power source, power source 29 may be recharged using any of a variety of techniques.

Body worn device 16 of FIG. 2 is provided for purposes of illustration. Body worn device 16 may include more or fewer components than those illustrated in FIG. 2. As such, the techniques of this disclosure should not be considered limited to the example described in FIG. 2.

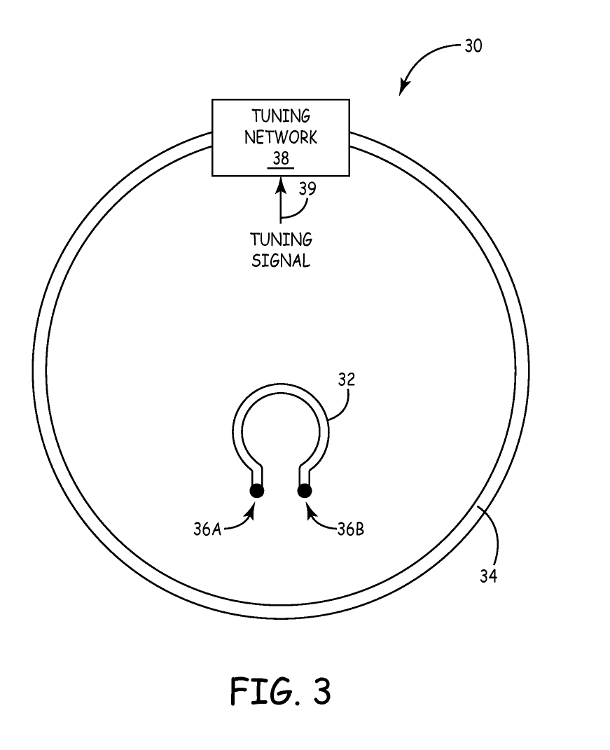

FIG. 3 is a schematic diagram illustrating an example multi-element antenna 30 in accordance with one aspect of this disclosure. Antenna 30 may correspond with antenna 23 of FIG. 2. Antenna 30 includes a first inner antenna element 32 disposed proximal to an outer antenna element 34. The inner and outer antenna elements may comprise an electrically conductive material. In the illustrative embodiment of FIG. 3, Antenna 30 is a dual loop antenna, with at least a loop segment of the outer antenna element 34 overlapping with a loop segment of the inner antenna element 32. Inner antenna element 32 and outer antenna element 34 are illustrated as including one turn of a conductive material. In other embodiments, however, inner antenna element 32, outer antenna element 34, or both may include more than one turn of the conductive material.

Inner antenna element 32 is electrically coupled to telemetry module 22 of body worn device 16 via feed points 36A and 36B (collectively “antenna feed-points 36”). Telemetry module 22 feeds signals to be transmitted to inner antenna element 32 via feed points 36. Outer antenna element 34 is magnetically coupled to inner antenna element 32. In other words, a change in current flow through inner antenna element 32 generates a magnetic field that couples the energy to outer antenna element 34. The multi-element structure, such as the nested dual loop, of antenna 30 increases the impedance of antenna 30 at the antenna feed point, thus providing a better impedance match (e.g., close to 50 Ohms) Moreover, because the inner antenna element 32 is electrically coupled to the transceiver and may be located anywhere, such as in an offset axis, near outer antenna element 34, antenna 30 provides flexibility as to the location of antenna feed-points 36.

Outer antenna element 34 may also include a tuning network 38 for tuning a resonant frequency of antenna 30. The tuning network 38 may include one or more components that facilitate the varying of the impedance of the antenna in response to changes to one or more electrical properties of the tuning network. Such changes may include but are not limited to varying an input such as a voltage or current to the tuning network. Such changes may also include providing digital control inputs/signals to the tuning network.

As described above, a tuning module of body worn device 16 may selectively apply or adjust tuning signal 39 to tuning network 38 based on whether body worn device 16 is on patient 12. In other examples, the antenna may be tuned as a function of one or more criteria. For example, the criteria feeding the tuning selection such as application of the tuning signal 39 by the tuning module may include the RSSI, a quality of service indicator, output of sensor 25 (FIG. 2) or input received from user interface 24 (FIG. 2). As described above, the tuning module may be processor 26, telemetry module 22 or other component of body worn device 16.

In one example embodiment, the tuning network 38 may comprise, for example, of a varactor, variable capacitor, or other element having a capacitance that can be controlled or adjusted. In the case of a varactor, tuning signal 39 may be a direct current (DC) bias voltage applied to the varactor. The impedance of the antenna may be tuned by selectively adjusting the tuning signal 39 to achieve a predetermined capacitance and therefore resonance frequency for optimal impedance matching. This may include varying the tuning signal 39, such as the DC bias voltage applied across the voltage-variable capacitor (varactor). In doing so, the multi-element antenna can be tuned to an impedance that is closely matched to the impedance of the transmission line. Although described in this example in the context of the tuning network 38 being a varactor and tuning signal 39 being a DC bias voltage for purposes of illustration, tuning network 38 may be any tunable element and tuning signal 39 may be any signal that adjusts the tuning network 38.

In another example, tuning network 38 may, in another example, comprise a configurable network of an array of switchable (selectable) capacitors and the tuning signal may activate one or more switches to switch all or a subset of the capacitors into and out of coupling with outer antenna element 34. The impedance of the antenna may be tuned by selecting the appropriate capacitor(s) to achieve a predetermined capacitance and therefore resonance frequency to achieve impedance matching. The tuning may also include varying the tuning signal 39, such as the voltage applied across the selected capacitor(s). In some implementations, the configurable network may include one or more non-switchable capacitors may be additionally coupled to the tuning network 38 in conjunction with the switchable capacitors.

In another embodiment, the tuning network 38 may comprise an inductor, such as a variable inductor, that is coupled to the outer antenna element. The impedance of the antenna may be adjusted by varying the inductance of the variable inductor to achieve a predetermined resonance frequency and thereby achieve impedance matching. The tuning may be achieved by selectively varying the tuning signal 39, such as a current (or voltage) applied to the variable inductor element.

In another embodiment, the tuning network 38 may comprise a switching network utilizing inductors. Tuning with the switched capacitor network may be achieved by varying the tuning signal 39 by, for example, implementing a switching scheme to determine which one or more inductors of the switched inductor network are coupled to a power source. A non-overlapping signal may be used to control the switches, so that not all switches are closed simultaneously. In another embodiment, the tuning network 38 may be implemented as a switching network utilizing a combination of capacitors and inductors.

In yet another embodiment, the tuning network 38 may be implemented as a configurable network including at least one switchable component (e.g., inductor or capacitor) and at least one non-switchable component (capacitor or inductor).

The tuning network 38 may be adjusted to optimize the operation of the antenna 30 based on its operating environment. In one example, the tuning module may apply a DC bias voltage to the varactor in response to determining that body worn device 16 is on patient 12 and remove the DC bias voltage in response to determining that body worn device 16 is not on patient 12. In the context of an implantable medical device, such as IMD 14, the tuning network 38 may be tuned to optimize the operation of antenna 30 for a range of implant environments. For example, the antenna 30 may be optimized for pre- and post-implant environmental operation. In other examples, the post implant operation may further be optimized as a function of the implant depth.

In additional embodiments, the tuning network may be implemented as a passively tuned network for self-tuning In other words, the tuning network 38 may comprise one or more components that permit passive self-tuning of the antenna based on changes in the dielectric medium. For instance, the passively-tuned network may comprise an inductor, interdigital capacitor and fixed capacitor coupled to the outer antenna element 34. In the implementation, the capacitance of the interdigital capacitive component would vary depending on the dielectric medium in which the antenna is exposed. As such, in response to the operating environment being air, which has a relative dielectric constant of approximately 1, the capacitance would increase primarily as a function of the dielectric constant where as in response to the operating environment in which the antenna is disposed comprises contact with the body, which has a dielectric constant approximately between 60 and 80, the network overall capacitance would decrease primarily as a function of the dielectric constant. With regard to the operating environment being air, the antenna will typically be a predetermined distance away from the body so as to eliminate or substantially minimize any contributory effects associated with the body's effective capacitance and dielectric constant.

The criteria employed to tune antenna 30 and thereby optimize its operation in the context of a body worn device 16 may include the output of sensor 25 or input from user interface 24. As such, the tuning module may apply a bias voltage having a first level in response to an indication that the body worn device 16 is worn on patient 12 and apply a bias voltage having a second level in response to an indication that the body worn device 16 is not worn on patient 12. Accordingly, applying the tuning signal (e.g., bias voltages in this example) changes the capacitance or inductance of tuning network 38 as a function of a given environment in which the antenna 30 is disposed to optimize the antenna operation for the given environment. For example, the capacitance or inductance of tuning network 38 may be decreased in response to IMD 14 being implanted or body worn device 16 being worn by patient 12. Conversely, the capacitance or inductance of tuning network 38 may be increased in response to IMD 14 being outside the body of patient 12 or body worn device 16 not being worn by patient 12.

In situations where the body worn device 16 is adjacent to the body or the IMD 14 has been implanted, the body of patient 12 may present an impedance that may manifest in electrical terms as, for example, a parallel capacitor increasing the overall capacitance. The capacitance or inductance of tuning network 38 is thus varied to compensate for the increased capacitance of the body. As such, removing the device from patient 12 causes an environmental change that is accounted for by the selective tuning of antenna 23.

In another example, the tuning module may apply the tuning signal to tunable tuning network 38 without determining the environment in which antenna 30 is operating (e.g., whether it is on a device that is adjacent to the body of patient 12, implanted in the body or away from the body). For example, the tuning module may apply the tuning signal based on the determined RSSI. The tuning module may receive the determined RSSI from telemetry module 22 and compare the RSSI to a threshold level. If the RSSI is below the threshold, the tuning module may apply the DC bias voltage to the varactor (if currently removed) or remove the DC bias voltage to the varactor (if currently applied). In this example, antenna 23 has two tuning selections: a first tuning selection in response to a DC bias voltage not being applied and a second tuning selection in response to the DC bias voltage being applied. Processor 26 may, however, be unaware of the operating environment of the antenna 30. In this manner, processor 26 tunes antenna 30 to account for any environmental changes, including whether body worn device 16 is worn by patient 12, but also including a temperature change of the environment, a change in moisture content of the environment, or any other environmental change that may affect the tuning of antenna 30.

Although the examples described above include two tuning selections (e.g., tuning signal applied and removed), body worn device 16 may be capable of including more than two tuning selections. In the case of a varactor or other tunable element, each of the tuning selections may correspond with a control signal(s). In the case the tuning network 38, including a plurality of fixed capacitors, each of the tuning selections may correspond with a different number of the capacitors being switched into outer antenna element 34. The tuning selections may be further used to achieve more optimal tuning of antenna 30. In one example, processor 26 may periodically scan all of the tuning selections and select the tuning selection resulting in the best RSSI. In another example, upon determining that the RSSI is below a threshold level, processor 26 may automatically switch tuning selections until the RSSI increases above the threshold level.

In embodiments where two or more tuning selection criteria are available, one criterion may be used as the primary criteria and a second or subsequent criteria may be used as the secondary tuning criteria. For example, processor 26 may initially tune antenna 30 based on whether body worn device 16 is on patient 12 (as described in detail above) and adjust the tuning to further refine antenna operation. For example, processor 26 may initially tune antenna 30 based on whether the output of sensor 25 or input from user interface 24 indicates that body worn device 16 is on patient 12 and then enhance the tuning of antenna 30 based on the RSSI.

In some instances, inner antenna element 32 may have either a capacitive tuning network or an inductive tuning network (not shown in FIG. 3). The capacitive or inductive tuning network on inner antenna element 32 may function as an additional tuning mechanism to tune the impedance of antenna 30. The capacitive or inductive tuning network on inner antenna element 32 may also be tunable based on the measured RSSI, output of sensor 25 or based on input received from user interface 24. In other instances, the tuning network on inner antenna element 32 is not tunable, i.e., fixed.

In other embodiments, additional criteria may be utilized for tuning the tuning network 38 of the antenna 30 to optimize its operation. In one example, the transmitted power may be monitored while tuning the antenna in order to maximize power transfer or, the tuning network 38 may be tuned to minimize reflections from the tuning network or, the ratio between the transmitted power and the reflected power may be monitored to determine the optimal impedance match of the antenna 30 to a transmission line (not shown) coupling the telemetry module 22 to inner conductive loop 34, for example, of antenna 30. The transmitted power and the reflected power may be sensed and a ratio of the two power levels used to indicate when a minimum standing wave ratio has been achieved. The tuning of the antenna 30 is deemed to be optimal when the standing wave ratio is at its lowest value. As such, during a transmitting operation by the antenna 30, the tuning network 38 is tuned until the standing wave ratio reaches a minimum value. The tuning of tuning network 38 may be performed prior to each transmission, each telemetry session, every hour, in response to a user input or at any other desired interval or input.

In another example, the reflected power may be measured and compared to a threshold value. Adjustments of the tuning network may subsequently be performed based on the results of the comparison of the reflected power to the threshold value. For instance, if the measured reflected power is greater than or lower than the threshold value, the capacitance or inductance of tuning element(s) within the tuning network 38 may be adjusted downward or upward to reduce or eliminate the impedance mismatch.

In other embodiments, the criteria used for tuning network 38 may include a quality of service metric. Such service metrics may include but are not limited to a bit error rate, a packet error rate, preamble errors, or a rate of forward error correction. As such, the tuning network 38 may be tuned in response to the quality of service metric to ensure that the most optimal value for the metric is achieved during the antenna 30 communication. For instance, the capacitance of tuning network 38 may be down or upward adjusted to reduce or eliminate the impedance mismatch as a function of the quality of service metric. In one example, a threshold value for the quality of service metric may be predetermined and the capacitance or inductance of tuning network 38 adjusted based on the result of the comparison between the threshold value and a monitored quality of service metric. In this manner, impedance matching of antenna 30 may be realized based on the quality of service metric thereby improving power transfer efficiency for the transmission and reception path.

Each of the above additional criteria for tuning the antenna 30 may suitably be used as the primary criteria for tuning or secondary criteria for fine-tuning as discussed in more detail above with respect to the capacitance or inductance of tuning network 38 and the RSSI-based tuning.

In the example illustrated in FIG. 3, inner antenna element 32 and outer antenna element 34 have a circular shape. However, inner antenna element 32 and outer antenna element 34 may be formed in any of a variety of shapes, including square, rectangle, triangle, oval or any other shape. The antenna elements may also be formed in a single dimensional configuration such as that illustrated in FIG. 3 or any other configurations such as spiraling or helical. Moreover, inner antenna element 32 and outer antenna element 34 need not be formed in the same shape. In other words, inner antenna element 32 and outer antenna element 34 may be of different shapes. The shapes of inner antenna element 32 and outer antenna element 34 may be dependent on a size and shape of body worn device 16 or other factor.

Likewise, the sizes of inner antenna element 32 and outer antenna element 34 may depend on the size and shape of body worn device 16, the frequency at which communication occurs, or the like. In one example, outer antenna element 34 is less than or equal to approximately one twentieth ( 1/20) of a wavelength at 400 MHz, e.g., approximately 3.75 centimeters (cm), and inner antenna element 32 is less than or equal to approximately one one-hundredth ( 1/100) of a wavelength at 400 MHz, e.g., approximately 7.5 millimeters (mm) As such, the antenna configuration described in this disclosure may provide a small size antenna that maintains a high radiation efficiency.

In the example illustrated in FIG. 3, inner antenna element 32 is located within outer antenna element 34. However, inner antenna element 32 may not be located within outer antenna element 34. Inner antenna element 32 may be located anywhere in which there is sufficient magnetic coupling between inner antenna element 32 and outer antenna element 34 to couple the signals between loops 32 and 34. Additionally, inner antenna element 32 and outer antenna element 34 may be coplanar or non-coplanar, coaxial or non-coaxial, collinear or non-collinear, or any combination thereof. Inner antenna element 32 and outer antenna element 34 may be located in parallel planes. In other embodiments, inner antenna element 32 and outer antenna element 34 may be located in different planes that are not parallel with one another, but are oriented such that there is sufficient magnetic coupling between inner antenna element 32 and outer antenna element 34.

Moreover, inner antenna element 32 and outer antenna element 34 may be separated by one or more layers of material. For example, inner antenna element 32 may be located within a housing of body worn device 16 while outer antenna element 34 is located outside the housing of body worn device 16 (e.g., on an outer surface of the housing or integrated as part of the housing). Alternatively, both inner antenna element 32 and outer antenna element 34 may be located within the housing of body worn device 16 or both located outside the housing of body worn device 16.

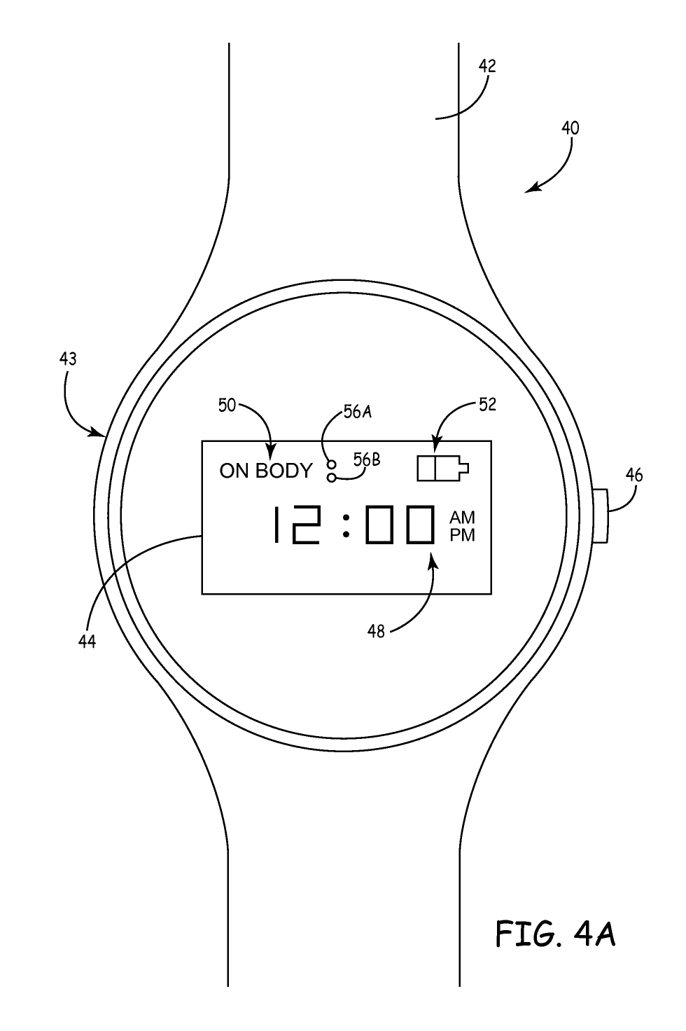

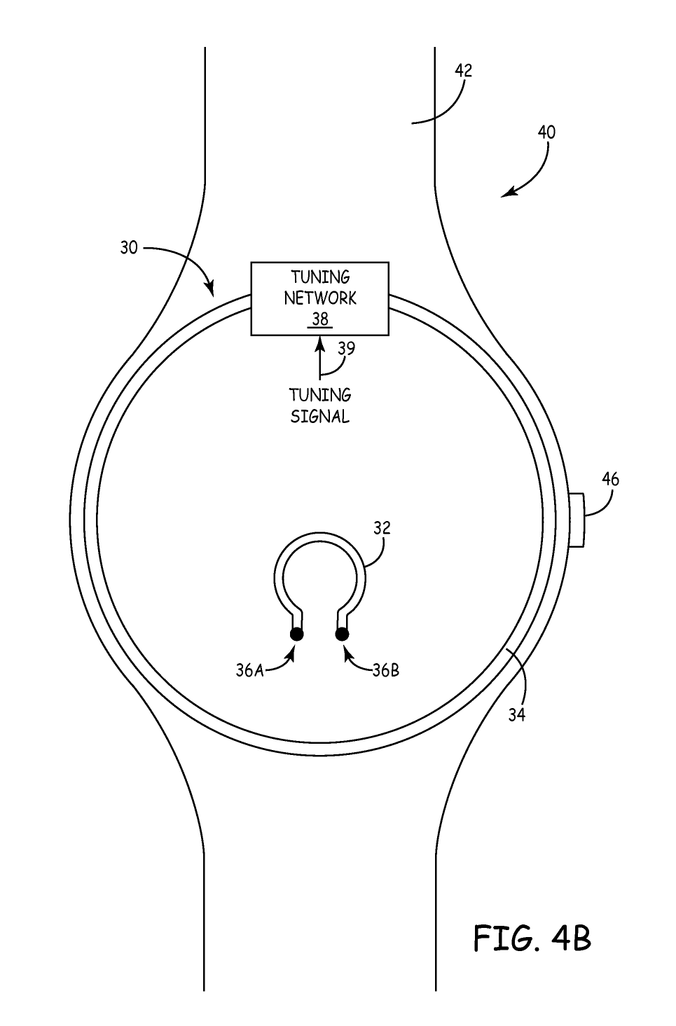

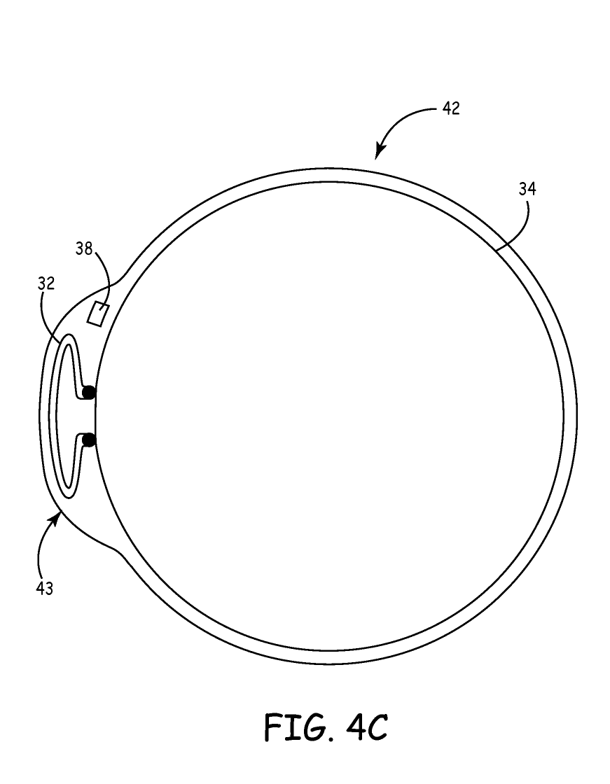

FIG. 4A is a schematic diagram of a wrist-worn device 40. In the example of FIG. 4A, wrist worn device 40 is a watch. Wrist worn device 40 includes a band portion 42 and a face portion 43 that includes a display 44 and a button 46. Display 44 and button 46 may form all or a portion of user interface 24 (FIG. 2). Band portion 42 may extend at least partially around a wrist of patient 12 and, in some instances, may include an attachment mechanism (not shown) to secure the two ends of band portion 42 together and keep wrist worn device 40 on patient 12. Band portion 42 may be made of a conductive material (e.g., metal) or a non-conductive material (e.g., rubber, plastic, leather, cloth or the like).

Display 44 is illustrated as a digital display that shows a number of different types of information. Display 44 may be a light emitting diode (LED) display, a liquid crystal display (LCD), or other suitable digital or electronic display. In the example illustrated in FIG. 4A, display 44 shows a time indicator 48, wear indicator 50 and power source indicator 52. In other examples, however, display 44 may show more or fewer types of information as well as other types of information. For example, display 44 may show one or more parameters that are measured by wrist worn device 40 (e.g., heart rate), one or more parameters that are measured by IMD 14 and transmitted to wrist worn device 40, or other information. The different types of information may be shown using any combinations of numbers, letters, symbols, icons or other indicia. In other instances, display 44 may be an analog display or a combination analog and digital display.

Wear indicator 50 indicates whether wrist worn device 40 is on patient 12. In the example illustrated in FIG. 4A, wear indicator 50 includes the words “ON BODY” and a pair of LEDs 56A and 56B. LED 56A may be a green LED that is lit up to indicate that antenna 30 is tuned for operating when wrist worn device 40 is on patient 12 and LED 56B may be a red LED that is lit up to indicate that antenna 30 is tuned for operating when wrist worn device 40 is not on patient 12. Such an indicator may be particularly useful when patient 12 is required to manually indicate when wrist worn device 40 is worn by patient 12, e.g., via button 46 or other input mechanism. However, wear indicator 50 may also be included on a wrist worn device 40 that senses when wrist worn device 40 is worn by patient 12 to provide a confirmation that such detection is successful. Although illustrated as a pair of LEDs, wear indicator 50 may take on any of a number of forms. For example, wear indicator 50 may be set to “ON BODY” when antenna 30 is tuned for operating when wrist worn device 40 is on patient 12 and set to “OFF BODY” when antenna 30 is tuned for operating when wrist worn device 40 is not on patient 12. For example, wear indicator 50 may be an icon of a human body (e.g., stick figure or more sophisticated icon) and turn on when antenna 30 is tuned for operating when wrist worn device 40 is on patient 12 and turn off when antenna 30 is tuned for operating when wrist worn device 40 is not on patient 12. Wear indicator 50 may be any sort of indicator that indicates whether antenna 30 is tuned for operating when wrist worn device 40 is on patient 12.

Power source indicator 52 provides an indication as to how much power is left in power source 29. Power source indicator 52 may enable patient 12 to recharge, change or otherwise take appropriate action prior to wrist worn device 40 running out of power.

FIG. 4B is a schematic diagram illustrating a top view of one example antenna configuration for wrist worn device 40. In the example of FIG. 4B, antenna 30 is located within face portion 43 of wrist worn device 40. Outer antenna element 34 of antenna 30 may extend substantially around a perimeter of face portion 43. A portion or all of outer antenna element 34 may be located outside a housing of wrist worn device 40 or form part of the housing of wrist worn device 40. For example, an outer portion of face portion 43 may be made from a conductive material to form outer antenna element 34 and/or tuning network 38. Alternatively, a majority of outer antenna element 34 may be outside of or part of the housing of wrist worn device 40 while tuning network 38 is located within the housing. In other instances, both outer antenna element 34 and tuning network 38 are located within the housing.

Inner antenna element 32 may also be located inside or outside of the housing of wrist worn device 40. Additionally, inner antenna element 32 may be located anywhere within face portion 43 depending on the configuration of other components of wrist worn device 40 (e.g., telemetry module 22, user interface 24, sensor 25, processor 26, memory 28, and power source 29 illustrated in FIG. 2). Inner antenna element 32 and outer antenna element 34 are oriented with respect to one another such that there is a sufficient magnetic coupling to couple signals between the loops. Inner antenna element 32 and outer antenna element 34 may be in the same plane (i.e., coplanar) or may be in different planes. In the case of different planes, the planes may be parallel planes or non-parallel planes that are oriented with respect to one another such that there is an adequate magnetic coupling between the loops.

As described with respect to FIG. 2, inner antenna element 32 is electrically coupled to a telemetry module (including a transmitter and/or receiver) located within the housing of wrist worn device 40 via feed points 36. Tuning network 38 is electrically coupled to a tuning module that provides tuning signal 39, such as a voltage source that provides a voltage signal.

FIG. 4C is a schematic diagram illustrating a side view of another example antenna configuration for wrist worn device 40 of FIG. 4A. In the example of FIG. 4C, outer antenna element 34 of antenna 30 may extend substantially around band portion 42 and a part of face portion 43. A portion or all of outer antenna element 34 may be located outside a housing of wrist worn device 40 or form part of the housing of wrist worn device 40. For example, band portion 43 may be made from a conductive material to form outer antenna element 34 and/or tuning network 38. As another example, band portion 43 may be made from a non-conductive material but include a wire or other conductive material embedded within the non-conductive band. Tuning network 38 may be located within face portion 43 or within a housing of face portion 43.

Inner antenna element 32 may be located within face portion 43. Inner antenna element 32 and outer antenna element 34 are oriented such that there is a sufficient magnetic coupling to couple signals between the loops. Inner antenna element 32 and outer antenna element 34 may be coplanar, in parallel planes or in non-parallel planes that are oriented with respect to one another such that there is an adequate magnetic coupling between the loops.

Wrist worn device 40 illustrated in FIGS. 4A-4C is one example of a body worn device in accordance with this disclosure. Other body worn devices that are either worn on the wrist or elsewhere are also within the scope of this disclosure. As such, body worn device 16 may be a bracelet, necklace, ring or other type of jewelry shaped device. Body worn device 16 may be a strap that is placed anywhere on the body of patient 12, e.g., around an arm, leg, ankle, waist, head, or anywhere else on patient 12. In some instances, body worn device may be integrated within a clothing article worn by patient 12.

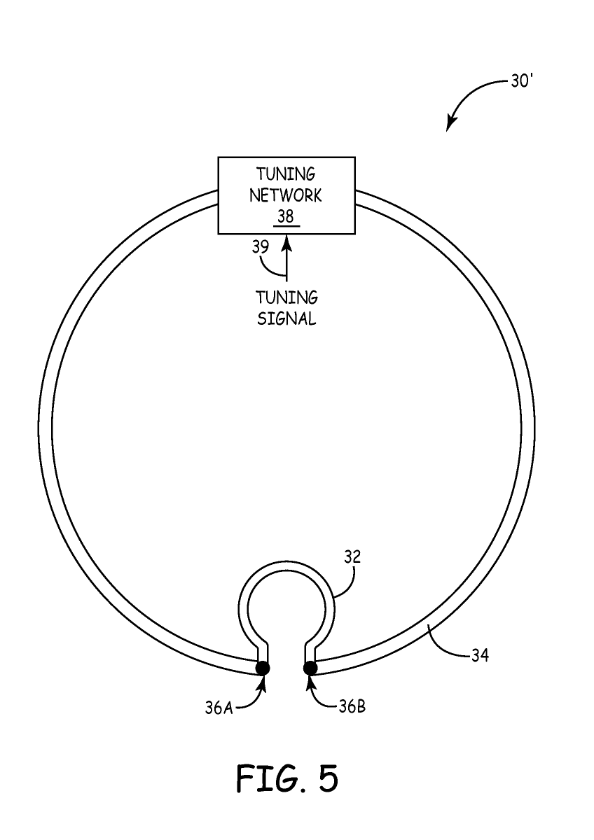

FIG. 5 is a schematic diagram illustrating another example multi-element antenna 30′. Antenna 30′ may correspond with antenna 30 of FIG. 2. Antenna 30′ conforms substantially to antenna 30 of FIG. 3, but both inner antenna element 32 and outer antenna element 34 are electrically coupled to telemetry module 22 via feed points 36. Although inner antenna element 32 and outer antenna element 34 are electrically coupled the configuration still has the advantages described above, e.g., larger impedance and tunability. Inner antenna element 32 and outer antenna element 34 may be electrically connected to one another at other locations than feed points 36.

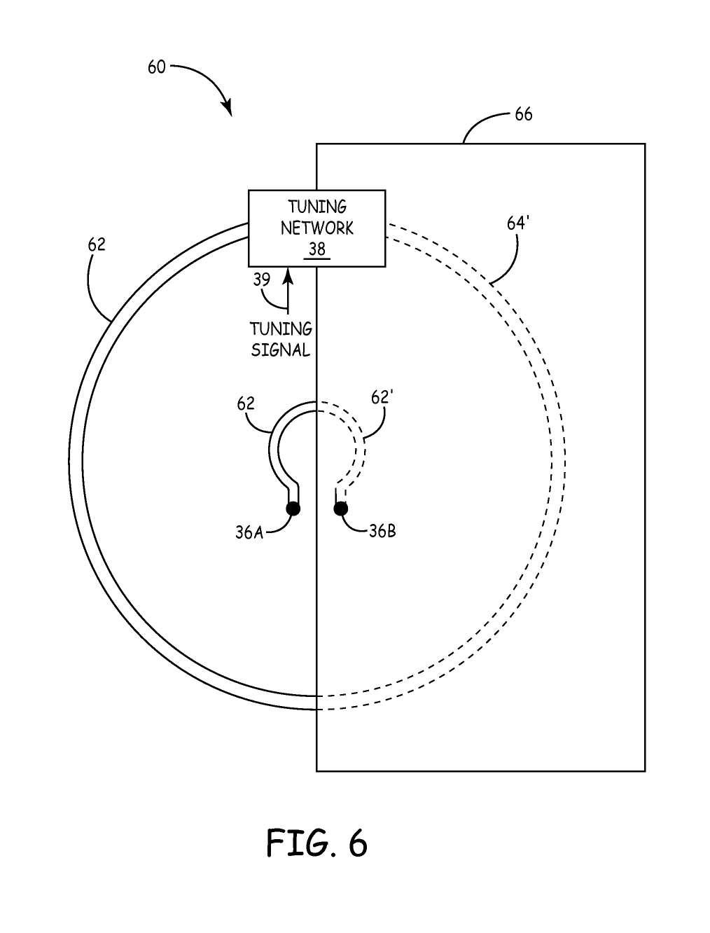

FIG. 6 is a schematic diagram illustrating another example antenna 60. Antenna 60 may correspond with antenna 23 of FIG. 2. Antenna 60 is a dual semi-loop antenna. Antenna 60 includes an inner semi-loop 62 and an outer semi-loop 64 located close to a ground plane 66. Ground plane 66 mirrors inner semi-loop 62 and outers semi-loop 64 to form mirrored semi-loop 62′ and mirrored semi-loop 64′, respectively. In operation, antenna 60 conforms substantially to operation of antenna 30.

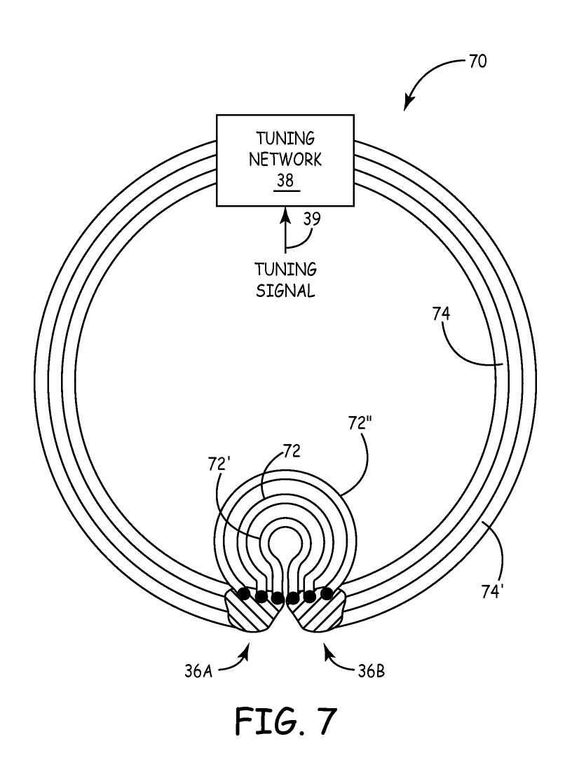

FIG. 7 is a schematic diagram depicting an alternative embodiment of a multi-element antenna 70. Antenna 70 may include a plurality of inner antenna elements 72′, 72, 72″ (collectively “72”) disposed proximate to a first outer antenna element 74. The plurality of inner antenna elements 72 may have varying sizes in terms of diameter or width. In one example, the plurality of inner antenna elements 72 may be nested in a planar orientation within the outer antenna element 74. According to this arrangement, one of the plurality of antennas may be selected and electrically coupled to telemetry module 22 via feed points 36. The selective electrical coupling may be implemented via a switching via a switching network (not shown) such as a digital or analog switches or multiplexers. In so doing, the selected one of the plurality of inner antenna elements 72 may be used to tune the antenna or to vary the bandwidth of antenna 70.

As further illustrated in FIG. 7, it should be readily understood that a plurality of outer antenna elements 74, 74′ (collectively, “74”) may be provided on antenna 70 and a suitable one of the plurality of outer antenna elements 74 selected to provide optimum impedance matching to the antenna, and for optimum antenna efficiency. In such an arrangement, a switching network may suitably be implemented to selective coupling of the desired outer antenna element.

As such, the plurality of inner antenna elements 72 and/or outer antenna elements 74 may be implemented in conjunction with the tuning network 38 described elsewhere in this disclosure. For ease of reference, the plurality of inner antenna elements 72 and/or outer antenna elements 74 will be referred to in this document as switchable tuning elements. One of the switchable tuning elements may be selectively electrically-coupled to define the inner antenna element and the outer antenna element. In doing so, the performance of antenna 70 is suitably optimized for impedance match and for the appropriate channels.

As with antenna 30, the antenna elements 72, 74 of antenna 70 may be formed in a variety of geometrical shapes including without limitation square, rectangle, triangle, oval, as well as spiraling and helical configurations. Moreover, the plurality of inner antenna elements 72 may be formed in different shapes and those may also differ from that of outer antenna element 74.

Additionally, the plurality of inner antenna elements 72 and outer antenna elements 74 may be coplanar or non-coplanar, coaxial or non-coaxial, collinear or non-collinear, or any combination thereof. Inner antenna elements 72 and outer antenna elements 74 may be located in parallel planes or located in non-parallel planes with an orientation that provides sufficient magnetic coupling between the selected inner antenna element 72 and outer antenna element 74.

In order to optimize operation of antenna 70, one or more tuning selection criteria may be monitored with the selection of the appropriate one of the inner antenna elements 72 or outer antenna elements 74 being based on the monitored criteria. Examples of such criteria have been discussed above with respect to the embodiments of antenna 30. These criteria include, without limitation, sensed proximity to the body, RSSI, transmission loss, return loss, reflected power, standing wave ratio, and various quality of service indicators.

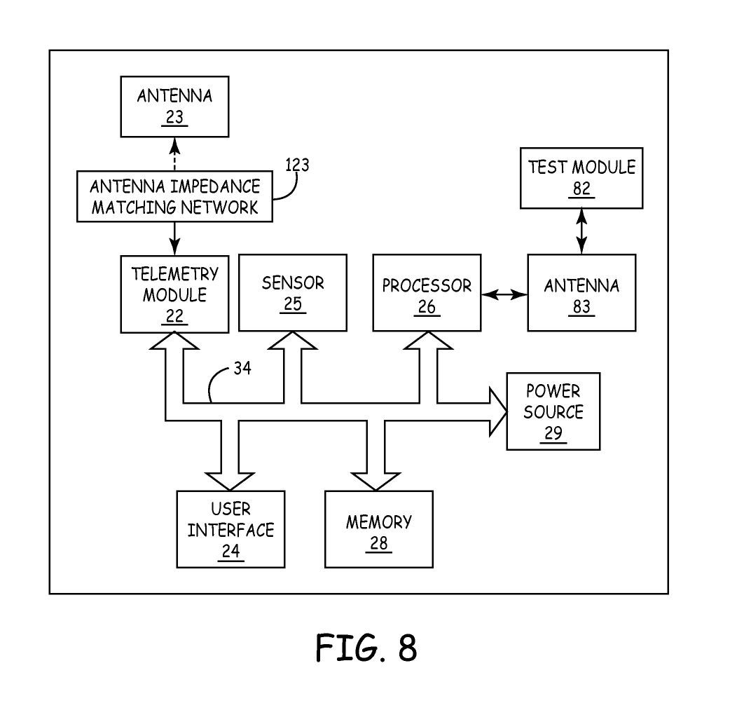

FIG. 8 is a schematic block diagram illustrating a system for real-time automatic self tuning of antennas of the present disclosure. According to this embodiment, a self-test module 82 may be incorporated into the IMD 14, or body worn device 16, or external device 18. However, the illustration of FIG. 8 solely depicts the self-test module 82 in conjunction with body worn device 16 for the sake of simplicity. Self-test module 82 may include a transceiver (not shown) and antenna 83 and is coupled to processor 26 for receiving control signals. Operably, self-test module 82 is controlled by processor 26 to generate a sequence of predefined test bytes that are received by antenna 83. Antenna 83 may be embodied as any of the aforementioned embodiments of antenna 30 or 70. The aforementioned tuning methodologies discussed in conjunction with the embodiments of antenna 30 and 70 may be utilized to tune the antenna 83 for optimized operation. The optimization may be accomplished by comparing the received test sequence with the transmitted test sequence with the optimal operation being determined as a function of the aforementioned criteria. The self tuning system of FIG. 8 may suitably be employed to prevent loss of a portion of a given received signal. The self tuning may be performed periodically, on pre-determined intervals, or in response to a user input or detection of a change in the operating environment of the antenna.

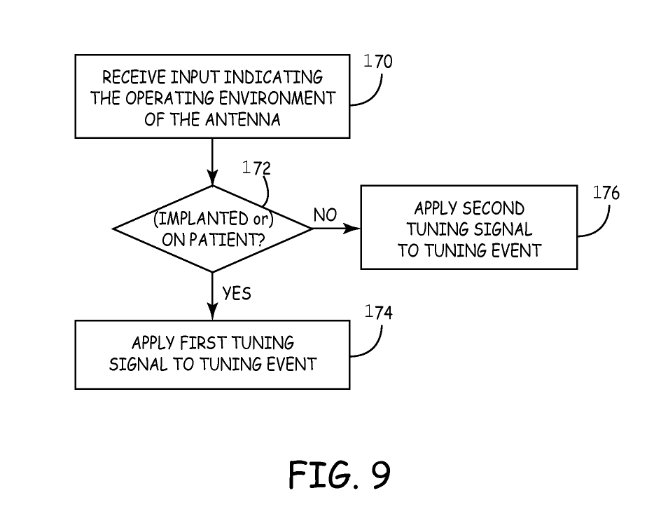

FIG. 9 is a flow diagram illustrating example operation of antenna 30 or 70 in accordance with one aspect of this disclosure. Body worn device 16 obtains input indicating whether body worn device 16 is on patient 12 (170). Processor 26 may receive input from telemetry module 22 indicating an RSSI of the received signals. In another example, processor 26 or other component of body worn device 16 may receive input from sensor 25 or a combination of sensors indicating whether body worn device 16 is on patient 12. For example, processor 26 may receive input from a proximity sensor having a capacitance that changes due to the proximity of sensor 25 to the skin of patient 12. As another example, processor 26 may receive input from one or more electrodes that detect cardiac electrical signals of patient 12. In other embodiments, processor 26 receives input from user interface 24 (e.g., button 46 of wrist worn device 40).

In the context of an implantable medical device, the antenna 30 or 70 may be tuned to optimize operation prior to implant and subsequent to implantation (170). IMD 14 may obtain input indicating whether IMD 14 has been implanted. The indication may be received directly from a user or automatically via one or more sensors that provide an indication of whether the IMD 14 has been implanted.

Processor 26 or other component of body worn device 16 or IMD 14 analyzes the input to determine the operating environment of the body worn device 16 or IMD 14 in relation to patient 12 (172). In other words, the determination is made as to whether the body worn device is on patient 12 or in the context of IMD 14, whether the IMD has been implanted within patient 12. If, for example, the antenna 30 or 70 is tuned for communication while body worn device 16 is worn on patient 12, processor 26 may determine that body worn device 16 is no longer on patient 12 based on the above-discussed tuning criteria. Conversely, if antenna 30 or 70 is tuned for communication when body worn device 16 is not worn on patient 12, processor 26 may determine that body worn device 16 is no longer on patient 12 in response to the tuning criteria. In the case of a proximity sensor, for example, the proximity sensor may output a “0” or “1” when an object is nearby or not, respectively, and processor 26 determines that body worn device 16 is on patient 12 when the output is a “0” and that body worn device 16 is not on patient 12 when the output is a “1”. As another example, processor 26 may analyze the input from the one or more electrodes and determine that body worn device 16 is on patient 12 when a cardiac electrical signal is detected. In the case of input from user interface 24, processor 26 may determine that body worn device 16 is on patient 12 upon receiving the input signal from user interface 24, e.g., upon actuation of button 46.

With respect to IMD 14, input from a sensor may be utilized to provide an indication of the depth of the implant within the body of patient 12, in addition to determining whether or not the IMD 14 has been implanted. Alternatively, or in addition, processor 26 may determine that IMD 14 has been implanted in patient 12 based on one or more of the above-discussed metrics for the tuning criteria.

Similarly, the capacitance or inductance of tuning network 38 of antenna 30 or 70 may be adjusted to compensate for the impedance difference that arises in response to IMD 14 being implanted within patient 12 verses outside the body of patient 12. Processor 26 will determine whether IMD 14 is implanted in the body of patient 12 (“YES” branch of block 172) and if so, the capacitance or inductance of tuning network 38 is adjusted to a first value (174). In response to determining that IMD 14 is not implanted in patient 12 (“NO” branch of block 172), the tuning module adjusts the capacitance or inductance of tuning network 38 to a second, higher value (176).

In response to processor 26 or other component of body worn device 16 determining that body worn device 16 is on patient 12 (“YES” branch of block 172), a tuning module adjusts the capacitance or inductance of tuning network 38 to a first value (174). In response to processor 26 or other component of body worn device 16 determining that body worn device 16 is not on patient 12 (“NO” branch of block 172), the tuning module adjusts the capacitance or inductance of tuning network 38 to a second, higher value (176). For example, the tuning module may apply a tuning signal (such as a DC bias voltage in the case of a varactor) when body worn device 16 is not on patient 12 and remove the tuning signal when body worn device 16 is on patient 12. In another example, the tuning module may apply a first tuning signal (e.g., voltage signal at a first voltage level) when body worn device 16 is not on patient 12 and apply a second tuning signal (e.g., voltage signal at a second voltage level) when the body worn device is not on patient 12. Any one of the first or second signals may be a default signal that is predetermined and stored in a memory of the device. In this manner, the capacitance or inductance of tuning network 38 is adjusted to tune the resonant frequency of the multi-element antenna based on whether body worn device 16 is on patient 12. Moreover, the change in capacitance may compensate for the impedance difference that occurs when body worn device 16 is worn by patient 12 versus not worn by patient 12.

In other embodiments, additional criteria may be utilized at block (170) in addition to or alternative to the determination of the operating environment of the body worn device 16 (worn or away from body of patient 12) and IMD 14 (implanted or away from body of patient 12). The additional criteria such as that discussed above may be utilized to further refine the tuning of the antenna for optimized operation.

The techniques described in this disclosure may be implemented, at least in part, in hardware, software, firmware or any combination thereof. For example, various aspects of the techniques may be implemented within one or more processors, including one or more microprocessors, DSPs, ASICs, FPGAs, or any other equivalent integrated or discrete logic circuitry, as well as any combinations of such components, embodied in programmers, such as physician or patient programmers, stimulators, or other devices. The term “processor” or “processing circuitry” may generally refer to any of the foregoing circuitry, alone or in combination with other circuitry, or any other equivalent circuitry.

Such hardware, software, or firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

When implemented in software, the functionality ascribed to the systems, devices and techniques described in this disclosure may be embodied as instructions on a computer-readable medium such as RAM, ROM, NVRAM, EEPROM, FLASH memory, magnetic data storage media, optical data storage media, or the like. The instructions may be executed to support one or more aspects of the functionality described in this disclosure.

Various examples have been described. It should be appreciated that the exemplary embodiments are only examples, and are not intended to limit the scope, applicability, or configuration of the disclosure in any way. Rather, the foregoing detailed description will provide those skilled in the art with a convenient road map for implementing the exemplary embodiments. It should also be understood that various changes can be made in the function and arrangement of elements without departing from the scope of the disclosure as set forth in the appended claims and the legal equivalents thereof.

What is claimed is:

1. An apparatus comprising:
a telemetry module; and
an antenna coupled to the telemetry module, the antenna comprising:
a first antenna element that is selectively electrically-coupled to the telemetry module via a feed point;
a second antenna element that is coupled to the first antenna element; and
a tuning network that is selectively tuned in response to an operating environment of the apparatus.

2. The apparatus of claim 1, further comprising a third antenna element that is selectively electrically-coupled to the telemetry module via the feed point, wherein one of the first antenna element and the third antenna element is coupled to the telemetry module via the feed point in response to the operating environment of the apparatus.

3. The apparatus of claim 1, wherein the tuning network comprises one of a variable capacitor and a varactor coupled to the second antenna element.

4. The apparatus of claim 1, wherein the tuning network comprises a configurable network having at least one switchable component and at least one non-switchable component.

5. The apparatus of claim 4, wherein the switchable component and the non-switchable component are selected from the group consisting of a capacitor and an inductor.

6. The apparatus of claim 1, wherein the tuning network comprises a configurable network having a plurality of switchable components.

7. The apparatus of claim 6, wherein the plurality of switchable components are selected from the group consisting of a capacitor and an inductor.

8. The apparatus of claim 1, wherein the tuning network comprises a passive network having a tuning element that passively adjusts an electrical characteristic in response to a change in the operating environment of the apparatus.

9. The apparatus of claim 1, further comprising a sensor to determine whether the apparatus is on the patient, wherein the tuning network is selectively tuned based on the output of the sensor.

10. The apparatus of claim 9, wherein the sensor comprises a proximity sensor.

11. The apparatus of claim 9, wherein the sensor comprises one or more electrodes.

12. The apparatus of claim 1, further comprising an input mechanism to receive input from a patient indicating whether the apparatus is on the patient, wherein the tuning network is selectively tuned based on the input received via the input mechanism.

13. The apparatus of claim 1, wherein the telemetry module determines a signal quality metric, the apparatus further comprising a processor that determines whether the apparatus is disposed on a patient based on the signal quality metric.

14. The apparatus of claim 13, wherein the signal quality metric is a received signal strength indicator (RSSI).

15. The apparatus of claim 1, further comprising a tuning module that generates tuning signals to apply to the tuning network, wherein the tuning module selectively applies the tuning signals to adjust an electrical characteristic of the tuning network to a first value in response to the apparatus being disposed in a first operating environment and to adjust the electrical characteristic of the tuning network to a second value in response to the apparatus being disposed in a second operating environment, wherein the first value is different than the second value.

16. The apparatus of claim 15, wherein the first operating environment comprises the apparatus being in contact with a body of a patient and the second operating environment comprises the apparatus being disposed a predetermined distance away from the body of the patient.

17. The apparatus of claim 15, wherein the tuning module applies a first tuning signal to the tuning network in response to the apparatus being disposed in a first operating environment and applies a second tuning signal to the tuning network in response to the apparatus being disposed in a second operating environment.

18. The apparatus of claim 17, wherein the first tuning signal and the second tuning signal are selected from the group consisting of a default tuning signal and a variable tuning signal.

19. The apparatus of claim 15, wherein the tuning module applies no tuning signal to the tuning network in response to the apparatus being disposed in a first operating environment and applies a tuning signal to the tuning network in response to the apparatus being disposed in a second operating environment.

20. The apparatus of claim 15, wherein the tuning signals comprise voltage signals.

21. The apparatus of claim 1, wherein the second antenna element is coupled to the first antenna element via at least one of an electrical coupling and a magnetic coupling.

22. The apparatus of claim 1, wherein the tuning network is electrically coupled to at least one of the first antenna element and the second antenna element.

23. The apparatus of claim 1, wherein the apparatus comprises one of an implantable medical device, a watch, a necklace, armband, belt, ring, bracelet and patch.

24. The apparatus of claim 1, wherein one of the first and second antenna elements are less than or equal to one twentieth ( 1/20) of a wavelength and the other of the first and second antenna elements is less than or equal to approximately one one-hundredth ( 1/100) of a wavelength at 400 MHz.

25. The apparatus of claim 1, wherein the operating environment is based on the proximity of the apparatus to a body of a patient.

26. A method comprising:
determining the operating environment in which a device is disposed; and
selectively tuning an antenna of the device based on the determination.

27. The method of claim 26, wherein the antenna comprises a first antenna element that is selectively electrically-coupled to a telemetry module via a feed point, a second antenna element that is coupled to the first antenna element, and a tuning network, wherein selectively tuning the antenna comprises selectively tuning the tuning network based on the determination of the operating environment of the device.

28. The method of claim 27, wherein the tuning network is selected from the group consisting of a capacitor, an inductor, a switched capacitor network, a switched inductor network, and a configurable component network including at least one switchable component and at least one non-switchable component.

29. The method of claim 27, wherein determining the operating environment of the device comprises obtaining an output from a sensor of the device.

30. The method of claim 27, wherein determining the operating environment of the device comprises obtaining an output from a proximity sensor of the device.

31. The method of claim 27, wherein determining the operating environment of the device comprises obtaining an output from one or more electrodes of the device.

32. The method of claim 27, further comprising:
receiving input from a patient indicating whether the device is on the patient,
wherein selectively tuning the antenna comprises selectively tuning the antenna of the device based on the input received from the patient.

33. The method of claim 27, wherein selectively tuning the antenna of the device based on the determination comprises:
adjusting a capacitance of the tuning network to a first value in response to the device being adjacent to a patient; and
adjusting the capacitance of the tuning network to a second value in response to the device not being adjacent to the patient, wherein the first value is different in relation to the second value.

34. The method of claim 33, wherein
adjusting the capacitance of the tuning network to the first value comprises applying a first tuning signal to the tuning network in response to the device being determined to be disposed adjacent to the patient, and
adjusting the capacitance of the tuning network to the second value comprises applying a second tuning signal to the tuning network in response to the device being determined to not be adjacent to the patient.

35. The method of claim 33, wherein
adjusting the capacitance of the tuning network to the first value comprises applying no tuning signal to the tuning network in response to the device being determined to be adjacent to the patient, and
adjusting the capacitance of the tuning network to the second value comprises applying a tuning signal to the tuning network in response to the device being determined to not be adjacent to the patient.

36. An apparatus comprising:
a telemetry module that determines signal quality metrics of received signals;
an antenna coupled to the telemetry module, the antenna comprising:
a first antenna element that is electrically coupled to the telemetry module via a feed point;
a second antenna element that is coupled to the first antenna element; and
a tuning network; and
a processor that analyzes the signal quality metric and selectively tunes the tuning network based on the signal quality metrics.
